(19) United States
(12) Patent Application Publication
(10) Pub. No.: US 2008/0309439 A1
(43) Pub. Date: Dec. 18, 2008

(54) Hazard free screened switch using magnetic flux and glass

(76) Inventor: Nawab Ikram Ullah Khan, Islamabad (PK)

Correspondence Address: NATH & ASSOCIATES PLLC, 112 South West Street, Alexandria, VA, 22314, US

(21) Appl. No.: 12/155,470

(22) Filed: Jun. 4, 2008

(30) Foreign Application Priority Data
Jun. 2, 2007 (PK) 634/2007

(51) Int. Cl. H01H 21/18

(52) U.S. Cl. 335/207; 200/304

(57) ABSTRACT

During the service for last more than 22 years in WAPDA the inventor experienced several fatal/non-fatal accidents due to electrocution. The victims were from WAPDA and Public as well of severe nature resulting into amputation of hands, arms and limbs of the body and indeed in many cases of electrocution resulting into death. Such accidents are indeed very shocking, painful for me to alarming degree.

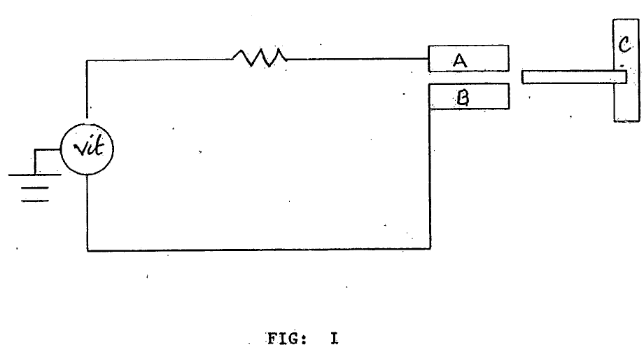

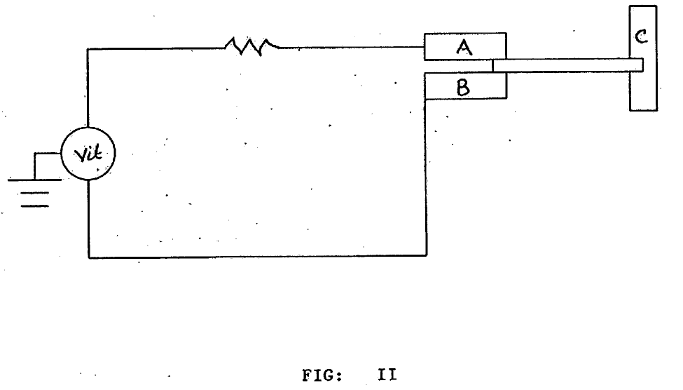

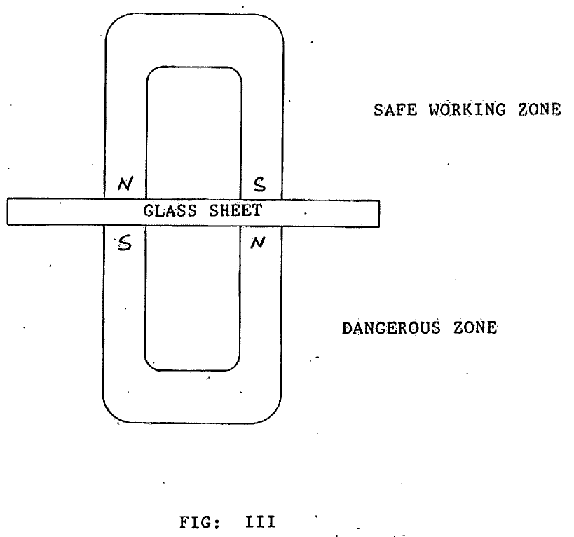

By the MERCY of ALLAH the inventor was moved by a motivating force to prevent these irreparable/irreversible losses and saving the precious lives of the people. Although it was not possible for the inventor to achieve 100% accident free system from sending end (power houses) to receiving end (grid station, power station houses) yet by the Leave of ALLAH the inventor has achieved 100% success in inventing the “Screened Switch” 100% free of electrical current.

By using flux instead of current, the life threatening danger and electrocution of all parts of body have now been overcome which is indeed a great achievement in the history of electrical engineering.

The chief beneficiaries from this invention are Engineers, Technical and Electricians (very prone to accidents) directly involved in performing operations for energizing mechanical and de-energizing electrical energy and vice versa. Now the inventor is satisfied to a considerable degree with his invention by eradicating life-taking hazards and by promoting safety from safe to the “safest” state of level at global level.

### FIELD OF THE TECHNOLOGY

This invention primarily relates to electrical engineering.

### BACKGROUND OF THE RELATED ART

It is indeed very important to analyze the concept of Magnetism that the magnetizing power can be utilized instead of electrical power in order to achieve the prime goal of safety at its peak (max) level. Magnetic power having no danger of electrocution due to non-existence of current. It is indeed very wise step to take full benefit from this energy and above all this energy can be transmitted from the good insulators preventing electrical energy from any kind of accident in case of fault of any nature occurring on the electrical network. Hence this invention plays a very important role as regards to safety of men involved in carrying out the operations.

### THE CLOSEST RELATED ART IS DESCRIBED AS FOLLOWS

Although many safety switches have been designed and are in operation but no such Magnetic Switches have been invented in which the use of glass has been exploited. Hence, this is the invention for the first time based on the fact the electrical current can never pass glass but magnetic flux can pass such insulators.

### THE TECHNICAL PROBLEM ADDRESSED BY THE INVENTION IS AS FOLLOWS

This invention is to be used and practically applied in the control rooms and switchyards of the powerhouses, grid stations and sub stations. Keeping in view the chief advantages of this invention, the zone is declared as the Control Room (in which people are present) while on the other hand the dangerous zone is declared as the Switchyard and Switch Room (where people are not available but equipment is installed).

### ADVANTAGES PRESENTED BY THE INVENTION ARE AS FOLLOWS

Albeit this invention has very long list of advantages but few of them are given below:
i. 100% hazard/electrical shock free for all electrical and mechanical operations in order to avoid any fatal/non-fatal accident. It can be employed in Grid Stations, Power Stations and Sub Stations.
ii. Acts like a remote control switch without having any energy and complicated electrical/electronic circuits, an excellent advantage never used before.
iii. Maintenance free due to its static design.
iv. Long life due to non-movement of static piece of device.
v. Diversification, compatibility and reliability depending upon the geometry and designs intended to perform a wide range of electromechanical operations.
vi. INSHA ALLAH advancement to multidirectional functions in all faculties of engineering from Biomedical Engineering to Space Engineering and Ocean Engineering. This invention can be used in swimming pools, Pharmaceutical industries, Robotics, Operation Theaters, Hospitals, and Rooms etc for excellent operations outputs.

### BRIEF DESCRIPTION OF THE DRAWINGS

An Electrical Circuit has been shown in FIG. I, wherein Vit is Voltage source, Z is impedance or Load with Contacts A, B and C. The contacts A and B are fixed but isolated from each other. This Diagram represents that the Circuit is OFF since I=0 as contract C is away from contacts A and B. This has been termed as de-energization phase.

As per FIG. II, when the magnet in the safest zone is moved towards the contacts A and B, the lower magnet having contract C comes in contact with contact A and B resulting into completion of operational Circuit because the current I start flowing and the system is energized. This process can be repeated as many times as required according to the need and circumstances of the Powerhouses or control room.

The diagram shown in FIG. III reflect the position of two horse Shoe magnets, one in the safest zone and the other in the danger zone. Operations carried out by moving the lower magnet in the dangerous zone, having contact C, which when attached with contact A and B, complete the circuit thus energizing the Electrical Circuit.

### DETAILED DESCRIPTION OF THE INVENTION WITH REFERENCE TO THE ACCOMPANYING DRAWINGS

As shown in FIG. III, Two permanent horseshoe magnets are used, one in the safest work zone and the other in the dangerous working zone. Glass is used to mark these two different zones. Glass is excellent insulator for the electrical current and very good medium for passage of magnetic flux. Both the magnets are coupled due to magnetic force of attraction sandwiching the glass. One upper magnet is in the safe zone and the lower magnet is in the dangerous zone as shown in FIG. III of the accompanying drawings.

Two electrical contacts A and B are provided as shown in FIGS. I and II, isolated from each other's in the safest zone. While the third contact, making and breaking the electrical circuit, is fixed on the lower magnet in the dangerous zone. When the manual force is applied to the upper magnet in the safe zone causing it to move too and fore, the lower magnet in the dangerous zone moves along with it. It is important to note that the contact “C”, fixed on the lower magnet, plays vital role in making and breaking the electrical circuit. Now the upper magnet is moved towards the two contacts (isolated from each others) the third contact upon touching these contacts complete the circuit and current starts flowing through these contacts. When the operation reversed i.e. the upper magnet is moved away from the two contacts (within the dangerous zone) the electrical circuit is immediately cut off and the flow of current is stopped.

Hence, making and breaking the electrical circuit have achieved the objectives. Therefore, in case of any electrical fault in the dangerous zone the current can never travel the safe zone protected by the excellent insulator i.e. glass.

The static devices having no movements are clean and free of all types of particles causing dirtiness for periodical maintenance. This invention is qualifying this quality in itself.

The static devices have no movements so the life of such devices is very long specially in this invention the flux constantly flowing through the two magnets verifies its long life it self. The numbers of operations are also eliminated, therefore, no chances of wear and tear. This invention plays a pivotal role on the part of remote control systems do require energy and complicated sensitive circuits to be used on both units i.e. controlling and the other operating one. But in this invention there are two static pieces of magnets generating flux without utilizing any other source of energy for operations. They do not require any sensitive circuits for both the controlling and operating units.

This switch is declared as remote one as there is a wall of glass of thickness “t” thus remotely controlled through distance “t” which can also be increased.

Since it is a static piece of device having constant flow of flux needs no maintenance.

The key design concept of this invention is safety to meet a very wide range of hazardous operating conditions without taking any risk at the cost of human lives. Chiefly while making and breaking the electrical circuits, allowing and stopping the flow of current. The conventional switches do not obey the concept of safety to its peak level as declared and proved by this invention by the Mercy of ALLAH.

1. A hazard free screened switch using magnetic flux and a glass sheet, comprising:
i) two permanent horseshoe magnets, an upper one located in a safe work zone and a lower one located in a dangerous working zone, which are connected with the help of the glass sheet that is an excellent insulator of an electrical current and is a very good medium for the passage of magnetic flux;
ii) two electrical contacts isolated from each other and located in the safe zone; and
iii) a third contact fixed on the lower magnet located in the dangerous zone makes and breaks an electrical circuit such that when a manual force is applied to the upper magnet located in the safe zone causing that magnet to move to and fro, the lower magnet located in the dangerous zone moves along with it so as to make or break the electrical circuit.

2. A switch as claimed in claim 1, where both the magnets are coupled due to magnetic force of attraction sandwiching the glass.

3. A switch as claimed in claim 1, where one of the two permanent magnets is on an upper side of the glass and the other of the two permanent magnets is on a lower side of the glass, the upper magnet is in the safe zone and the lower magnet is in the dangerous zone.
